(19) United States
(12) Patent Application Publication
(10) Pub. No.: US 2021/0072560 A1
(43) Pub. Date: Mar. 11, 2021

(54) Combined Reading Glasses and Sun Glasses

(71) Applicant: SH Produkter AS, Trondheim (NO)

(72) Inventor: Stein Hofstad, Trondheim (NO)

(21) Appl. No.: 17/013,911

(22) Filed: Sep. 8, 2020

Related U.S. Application Data
(60) Provisional application No. 62/896,831, filed on Sep. 6, 2019.

(51) Int. Cl. G02C 7/02; G02C 3/00

(52) U.S. Cl. CPC G02C 7/02; G02C 2200/08; G02C 3/003

(57) ABSTRACT

Combined reading glasses and sunglasses comprising a spectacle frame having a first and second lens rim, mutually connected by a bridge having a first side and a second side with each of the first side and second side configured to rest on a wearer's nose. A sunglass lens and a reading glass lens are positioned inside each lens rim, forming an interface therebetween. The glasses have a first and second side bar connected pivotal to the respective first and second lens rim. The glasses are formed substantially symmetrical about an axis extending between the first and second side bar, wherein a distance d between the first side of the bridge and the interface is about 8 mm, and the thickness t of the bridge between first and second side of the bridge is about 4 mm. The bridge includes four bridge projections for nose support.

### BACKGROUND

The present disclosure is related to combined reading glasses and sunglasses.

There are bifocal glasses, including sunglass lenses, having a reading glass lens at the bottom of the rim, and sun glass lenses, optionally with lens power at the upper part of the rim. However, glasses of this type have the disadvantage that the user does not obtain clear vision when the user is moving downward in steep terrain or in stairs, since the reading glasses are adapted to focus upon objects located close to the eyes.

JP H07159733 describes bifocal glasses where embodiments are formed symmetrically about an axis extending between the sidebars. In one embodiment, the ear connectors are arranged pivotal about the accompanying side bar.

US 2014/0354939 describes glasses having a case attached to the rear part of the side bars, serving as a place holder for personal belongings, such as credit cards and keys.

### SUMMARY

The inventive embodiments provide combined reading glasses and sunglasses, which also can be used when walking downward steep terrain or in stairs, without having to take off the glasses. The embodiments provide a single pair of glasses, which can replace two pairs of glasses, and which allow a wearer to read text on for example smartphones. The embodiments also provide glasses of this type that can be used for storing personal belongings, for example when swimming.

The aforementioned functions and advantages over known devices are provided by the disclosed embodiments of glasses which include substantially symmetrical bifocal sunglasses that can be turned upside down between a sunglasses mode and a reading glasses mode, said glasses comprising:

a spectacle frame having a first lens rim and a second lens rim, mutually connected by a bridge having a first side and a second side, wherein

a sunglass lens is arranged at a first area of and inside the respective lens rim, and

a reading glass lens is arranged at a second area inside of and inside the respective first and second lens rim, opposite and adjacent to said first area, thus forming an interface there between,

wherein a first and second side bar are connected pivotal to the first and second lens rim, respectively, said glasses being formed substantially symmetrically about an axis extending between the first and second side bar, wherein

a distance d between the first side of the bridge and the interface is preferably within an approximate range from about 7 mm to about 9 mm,

a thickness t between the top side and the underside of the bridge is preferably within an approximate range from about 3 mm to about 5 mm, and

wherein the bridge is provided with a first pair of bridge projections, arranged at the first side of the bridge, and a second pair of bridge projections, arranged at the second side of the bridge. The bridge projections serve as nose support to stabilize the glasses during use.

The distance d between the first side of the bridge and the interface is preferably about 8 mm, whereas the thickness t is preferably about 4 mm.

The end of the first and second side bar located most distant from the lenses are preferably provided with substantially symmetrical side bar projections extending a distance away from the side bar in a direction perpendicular to said axis. The side bar projections serve as stop and support means toward the ears of the person to further stabilize the glasses during use.

### BRIEF DESCRIPTION OF THE DRAWINGS

The invention is in the following described in further details by means of drawings, where

FIG. 1 shows combined reading glasses and sunglasses, viewed in perspective from the front,

FIGS. 2A and 2B show the use of the glasses in FIG. 1,

FIG. 3A shows a person wearing the combined reading glasses and sunglasses in a sunglass mode,

FIG. 3B shows a person wearing the combined reading glasses and sunglasses in a reading glasses mode, and

FIG. 4 shows the combined reading glasses and sunglasses in perspective from behind.

### DETAILED DESCRIPTION

Among the benefits and improvements disclosed herein, other objects and advantages of the disclosed embodiments will become apparent from the following wherein like numerals represent like parts throughout the several figures. Detailed embodiments of combined reading glasses and sunglasses are disclosed; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrase “in some embodiments” as used herein does not necessarily refer to the same embodiment(s), though it may. The phrases “in another embodiment” and “in some other embodiments” as used herein do not necessarily refer to a different embodiment, although it may. Thus, as described below, various embodiments may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.

Further, the terms “substantial,” “substantially,” “similar,” “similarly,” “analogous,” “analogously,” “approximate,” “approximately,” and any combination thereof mean that differences between compared features or characteristics is less than 25% of the respective values/magnitudes in which the compared features or characteristics are measured and/or defined.

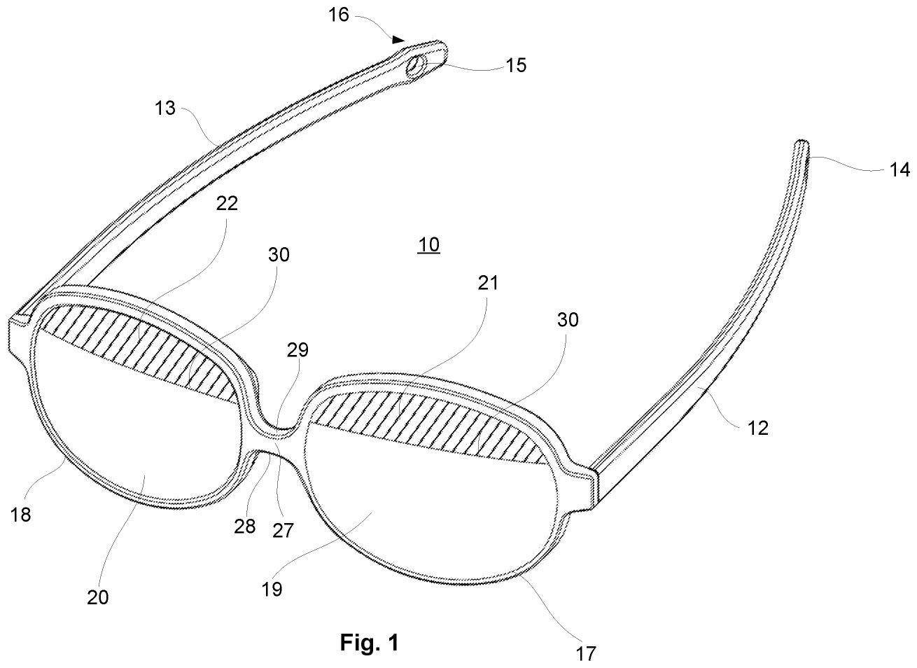

Now referring to FIG. 1, a substantially symmetrical combined reading glasses and sunglasses is shown in perspective from the front. The glasses 10 comprises a spectacle frame having a first lens rim 17 (right hand side) and a second lens rim 18 (left hand side), mutually connected by a bridge 27 also serving as nose support. A first and second lens pair is arranged inside the respective first and second lens rims, wherein the first lens pair comprises a sunglass lens 19, and a reading glass lens 21 attached within the first lens rim 17, and the second lens pair comprises correspondingly a sunglass lens 20 and a reading glass lens 22 attached within in the second lens rim 18. The respective sunglass lens and reading glass lens pairs 19, 21 and 18, 22 are arranged adjacent to each other thus forming an interface 30 there between. The sunglass lenses 19 and 20 are typically tinted darker than clear or ambient like standard sunglass lenses.

A first and second side bar 12 and 13 are each connected pivotal to the first and second lens rim 17 and 18, respectively.

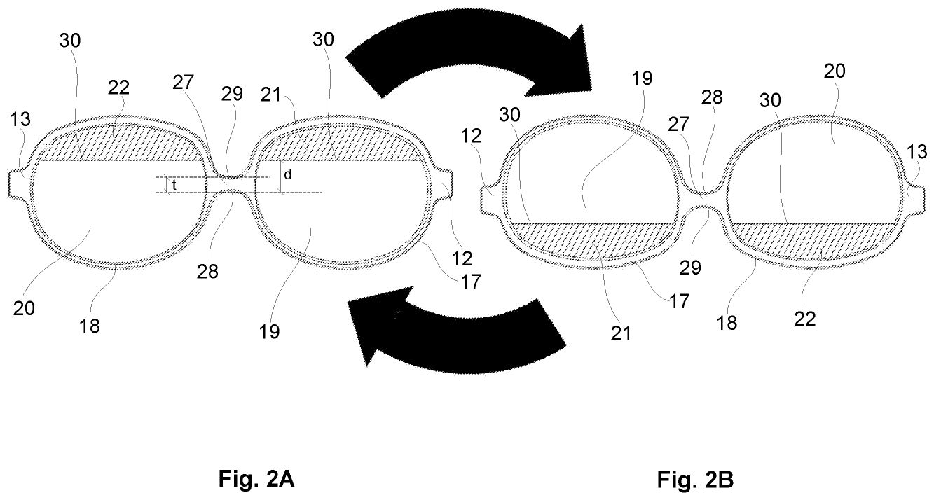

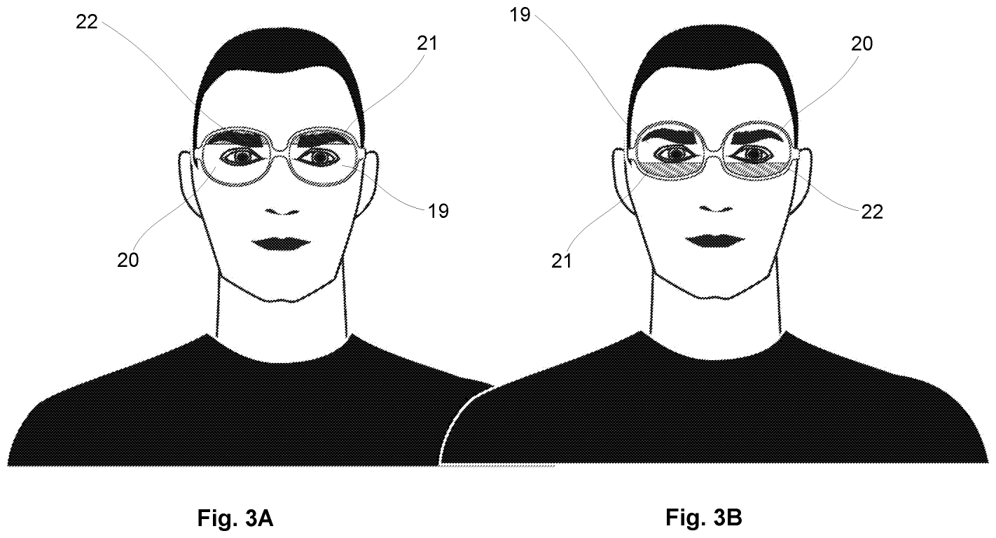

Now referring to FIGS. 2A, 2B, 3A and 3B, the two modes of use are shown.

FIGS. 2A and 3A show a sunglass mode where the reading glass lenses 21 and 22 are located at the top, whereas the sunglass lenses 19 and 20 are located at the bottom.

FIGS. 2B and 3B show a reading glasses mode with the reading glass lenses 21 and 22 arranged at the bottom, whereas the sunglass lenses 19 and 20 are located at the top.

FIG. 2A indicates dimensions, where reference sign d shows the distance between the first side of the bridge 27 and the lower edge of the reading glass lenses 21 and 22 represented by said interface 30. In order to make sure that the reading glass lenses 21 and 22 stay out of the field of vision in the sunglasses mode, the distance d must be within the range of about 7 to about 9 mm, preferably about 8 mm. Similarly, the thickness t of the bridge 27 should be within the range of about 3 to about 5 mm, preferably about 4 mm, in order to make sure that the reading glass lenses 21 and 22 will be located below the lower part of the eyes of a person wearing the glasses. Accordingly, in the reading glasses mode the glasses may serve both as reading glasses and sunglasses.

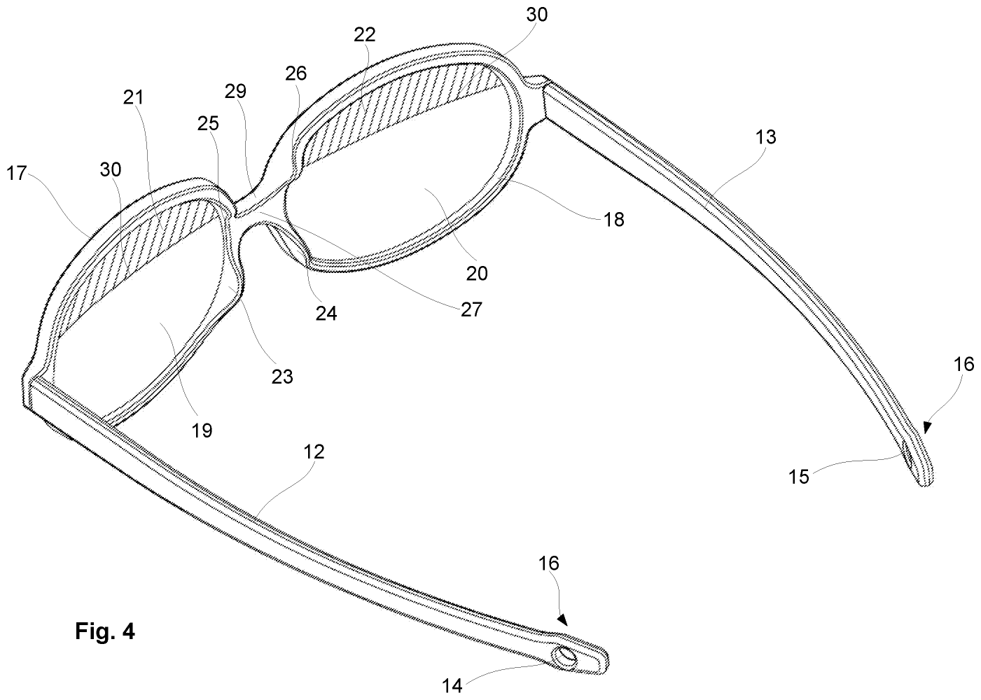

FIG. 4 shows the substantially symmetrical combined reading glasses and sunglasses, in perspective from the rear and above. The rear end (farthest away from the lenses) of the side bars 12, 13 are provided with side bar projections 16, extending a distance upward and downward in the use position of the glasses. The side bar projections 16 serve as stop and support means against the wearer's ears. Moreover, the bridge 27 is provided with four bridge projections represented by a first pair of bridge projections 23, 24, formed as extensions of the bridge 27 at the first side 28 of the same, and a second pair or bridge extensions 25, 26, also formed as extensions of the bridge 27 at the second side 29 of the same. The bridge extensions 23, 24, 25, 26 extend in a direction into the internal side of the glasses, serving as support to the nose. Consequently, each of the first side 28 (bottom in sunglasses mode) of the bridge and second side 29 (bottom in reading glasses mode) of the bridge is configured to separately be received and supported by the nose of a wearer.

FIG. 3B shows a use a situation where the wearer is reading a handheld device, such as a smartphone, or is driving a car studying the control panel of the car through the reading glass lenses. In FIG. 3A the wearer is in a situation moving downward steep terrain or stairs, and in a need of amending the strength of the glasses in the lower field of vision. Thanks to the design of the glasses, the user can simply turn the glasses upside down and hence maintain good vision of the steep terrain or the stairs sloping downward.

As is apparent from the above, the glasses in accordance with the invention alleviate motion down stairs or steep terrain. However, the glasses also replace the need for two separate pairs of glasses, a separate pair of reading glasses and a separate pair of sunglasses. It should be mentioned that the need for reading glasses has increased the latest years because of digitalization which involves increased use of for example smart phones. Elder workers will also benefit from the present invention, e.g. at work.

What is claimed is:

1. Combined reading glasses and sunglasses (10), comprising
a spectacle frame having a first lens rim (17) and a second lens rim (18), connected to one another by a bridge (27) having a first side (28) and a second side (29);
a sunglass lens (19; 20) positioned within each of the first lens rim (17) and second lens rim (18) at a respective first area thereof; and
a reading glass lens (21; 22) positioned within each of the first lens rim (17) and second lens rim (18) at a respective second area thereof, opposite and adjacent to said respective first area, thereby forming an interface (30) between the reading glass lens (21) and sunglass lens (19) in the first lens rim (17) and between the reading glass lens (22) and sunglass lens (20) in the second lens rim (18);
a first side bar (12) pivotally connected to the first lens rim (17) and a second side bar (13) pivotally connected to the second lens rim (18), wherein
said glasses (10) are substantially symmetrical about an axis extending between the first and second side bar (12; 13) and configured to be turned upside down between a sunglasses mode with the respective sunglass lenses (19; 20) at a bottom position and a reading glasses mode with the respective reading lenses (21; 22) at the bottom position.

2. The combined reading glasses and sunglasses (10) of claim 1, wherein the bridge (27) is provided with a first pair of bridge projections (23, 24), arranged at the first side (28) of the bridge, and a second pair of bridge projections (25, 26), arranged at the second side (29) of the bridge (27).

3. The combined reading glasses and sunglasses (10) of claim 2, wherein
a distance d between the first side (28) of the bridge (27) and the interfaces (30) is from about 7 mm to about 9 mm, and
the thickness t between the top side and the underside of the bridge (27) is within the range from about 3 mm to about 5 mm.

4. The combined reading glasses and sunglasses (10) of claim 1, wherein
a distance d between the first side (28) of the bridge (27) and the interfaces (30) is from about 7 mm to about 9 mm, and
the thickness t between the top side and the underside of the bridge (27) is within the range from about 3 mm to about 5 mm.

5. The combined reading glasses and sunglasses (10) of claim 3, wherein the distance d is about 8 mm.

6. The combined reading glasses and sunglasses (10) of claim 4, wherein the distance d is about 8 mm.

7. The combined reading glasses and sunglasses (10) of claim 3, wherein the thickness t is about 4 mm.

8. The combined reading glasses and sunglasses (10) of claim 4, wherein the distance d is about 8 mm.

9. The combined reading glasses and sunglasses (10) of claim 3, wherein the distance d is about 8 mm and the thickness t is about 4 mm.

10. The combined reading glasses and sunglasses (10) of claim 1, wherein the end of the first and second side bar (12, 13) located most distant from the lenses are provided with substantially symmetrical side bar projections (16), said side bar projections extending a distance away from the side bar in a direction perpendicular to said axis.
